(19) United States
(12) Patent Application Publication
(10) Pub. No.: US 2016/0258765 A1
(43) Pub. Date: Sep. 8, 2016

(54) APPARATUS, METHOD, AND PROGRAM PRODUCT FOR REDUCING ROAD TRAVEL COSTS

(71) Applicant: LENOVO (Singapore) PTE, LTD., New Tech Park (SG)

(72) Inventors: Nathan J. Peterson, Durham, NC (US); John Scott Crowe, Durham, NC (US); Jennifer Lee-Baron, Morrisville, NC (US); Amy Leigh Rose, Chapel Hill, NC (US)

(21) Appl. No.: 14/635,157

(22) Filed: Mar. 2, 2015

(51) Int. Cl. G01C 21/34; G06Q 30/02

(52) U.S. Cl. CPC G01C 21/34; G06Q 30/0284

(57) ABSTRACT

Apparatuses, methods, and program products are disclosed for reducing road travel costs. By use of a processor, multiple routes that a vehicle may traverse to get from a starting point to a selected destination are determined. A projected mileage that the vehicle will traverse to get from the starting point to the selected destination for each route is dynamically calculated. A cost associated with each route is determined based at least in part on the projected mileage for the respective route.

### FIELD

The subject matter disclosed herein relates to road travel and more particularly relates to reducing road travel costs.

### BACKGROUND

### Description of the Related Art

Information handling devices, such as desktop computers, laptop computers, vehicle integrated computers, tablet computers, smart phones, optical head-mounted display units, smart watches, etc., are ubiquitous in society. These information handling devices may include navigation systems to facilitate navigation to a selected destination. For example, these navigation systems may be used to select a route for road travel from a starting point to the selected destination. The logic used to select the route may be based on a distance along the route or an anticipated time to travel along the route. The overall cost of certain routes selected by the navigation system may be more expensive than alternative routes.

### BRIEF SUMMARY

An apparatus for reducing road travel costs is disclosed. A method and computer program product also perform the functions of the apparatus. In one embodiment, the apparatus includes a processor and a memory that stores code executable by the processor. The code, in various embodiments, determines multiple routes that a vehicle may traverse to get from a starting point to a selected destination. In a further embodiment, the code dynamically calculates a projected mileage that the vehicle will traverse to get from the starting point to the selected destination for each route. The code may determine a cost associated with each route based at least in part on the projected mileage for the respective route.

In a further embodiment, the code transmits the cost associated with each route in conjunction with the routes to a display device to enable selection of a route. In some embodiments, the code that determines the cost associated with each route uses vehicle data to determine the cost. In such an embodiment, the vehicle data includes at least one of data corresponding to gas mileage, fuel tank level, idle time, frequency of starting, frequency of stopping, depreciation, wear and tear, age, speed, and usage of the vehicle.

In another embodiment, the code that determines the cost associated with each route uses data having at least one of toll prices, toll accounts, fuel prices, discount programs, traffic data, crime rates, accident rates, road conditions, and weather data to determine the cost. In a further embodiment, the code determines a travel time associated with each route and transmits the cost and the travel time associated with each route in conjunction with the routes to a display device to enable selection of a route based on the cost and the travel time.

In some embodiments, the code that determines the multiple routes that the vehicle may traverse to get from the starting point to the selected destination also determines fuel dispensing locations included in each route. In such an embodiment, the code may determine an amount of fuel to dispense at each fuel dispensing location. The fuel dispensing locations and the amount of fuel to dispense may be determined based at least in part on a price of fuel at a respective fuel dispensing location.

A method for reducing road travel costs, in one embodiment, includes determining, by use of a processor, multiple routes that a vehicle may traverse to get from a starting point to a selected destination. In some embodiments, the method includes dynamically calculating a projected mileage that the vehicle will traverse to get from the starting point to the selected destination for each route. In a further embodiment, the method includes determining a cost associated with each route based at least in part on the projected mileage for the respective route.

In some embodiments, the method includes transmitting the cost associated with each route in conjunction with the multiple routes to a display device to enable selection of a route of the multiple routes. In another embodiment, the method includes determining a route with the lowest cost. In some embodiments, determining the cost associated with each route includes using vehicle data to determine the cost. In such embodiments, the vehicle data may include at least one of data corresponding to gas mileage, fuel tank level, idle time, frequency of starting, frequency of stopping, depreciation, wear and tear, age, speed, and usage of the vehicle.

In some embodiments, determining the cost associated with each route includes using data having at least one of toll prices, toll accounts, fuel prices, discount programs, traffic data, crime rates, accident rates, road conditions, and weather data to determine the cost. In a further embodiment, the method includes determining a travel time associated with each route and transmitting the cost and the travel time associated with each route in conjunction with the multiple routes to a display device to enable selection of a route based on the cost and the travel time.

In certain embodiments, determining the multiple routes that the vehicle may traverse to get from the starting point to the selected destination includes determining fuel dispensing locations included in each route. In such embodiments, the method may include determining an amount of fuel to dispense at each fuel dispensing location. The fuel dispensing locations and the amount of fuel to dispense may be determined based at least in part on a price of fuel at a respective fuel dispensing location.

In one embodiment, a program product includes a computer readable storage medium that stores code executable by a processor. The executable code, in certain embodiments, includes code to perform determining multiple routes that a vehicle may traverse to get from a starting point to a selected destination. In a further embodiment, the executable code includes code to perform dynamically calculating a projected mileage that the vehicle will traverse to get from the starting point to the selected destination for each route. The executable code, in some embodiments, includes code to perform determining a cost associated with each route based at least in part on the projected mileage for the respective route.

In certain embodiments, the code that performs determining the cost associated with each route also performs using vehicle data to determine the cost. The vehicle data may include at least one of data corresponding to gas mileage, fuel tank level, idle time, frequency of starting, frequency of stopping, depreciation, wear and tear, age, speed, and usage of the vehicle. In some embodiments, the code that performs determining the cost associated with each route also performs using data having at least one of toll prices, toll accounts, fuel prices, discount programs, traffic data, crime rates, accident rates, road conditions, and weather data to determine the cost.

In further embodiments, the code that performs determining the multiple routes that the vehicle may traverse to get from the starting point to the selected destination also performs determining fuel dispensing locations included in each route and determining an amount of fuel to dispense at each fuel dispensing location included in each route. The fuel dispensing locations and the amount of fuel to dispense are determined based at least in part on a price of fuel at a respective fuel dispensing location.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a system for reducing road travel costs;

FIG. 2 is a schematic block diagram illustrating one embodiment of another system for reducing road travel costs;

FIG. 3 is a schematic block diagram illustrating one embodiment of a further system for reducing road travel costs;

FIG. 4 is a map illustrating one embodiment of potential routes that may be taken from a starting point to a selected destination;

FIG. 5 is a schematic flow chart diagram illustrating one embodiment of a method for reducing road travel costs; and

FIG. 6 is a map illustrating another embodiment of potential routes that may be taken from a starting point to a selected destination.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. These code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

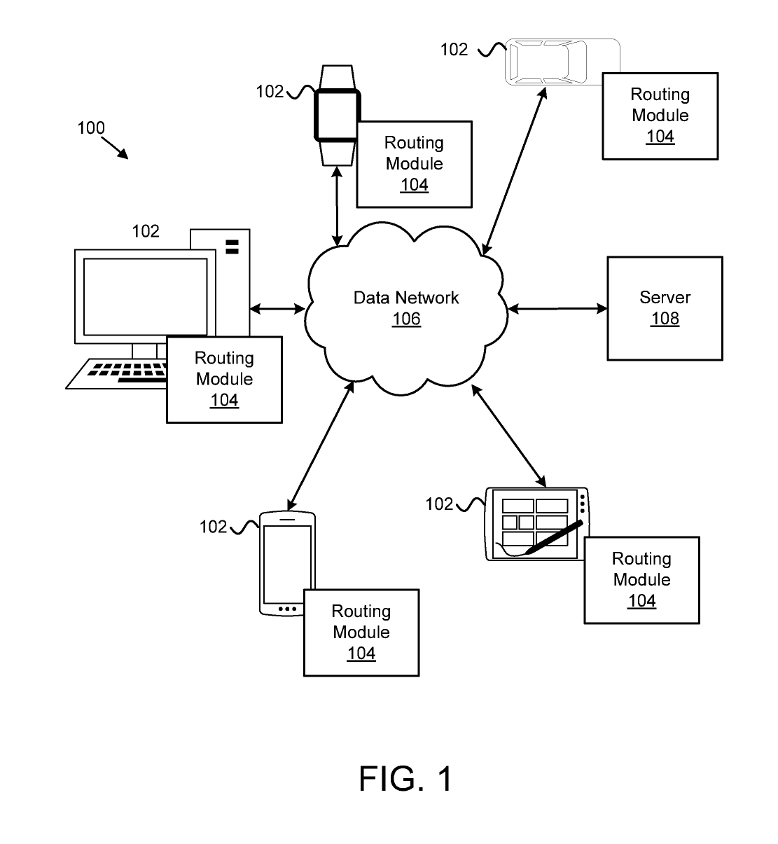

FIG. 1 depicts one embodiment of a system 100 for reducing road travel costs. In one embodiment, the system 100 includes information handling devices 102, routing modules 104, data networks 106, and servers 108. Even though a specific number of information handling devices 102, routing modules 104, data networks 106, and servers 108 are depicted in FIG. 1, one of skill in the art will recognize that any number of information handling devices 102, routing modules 104, data networks 106, and servers 108 may be included in the system 100.

In one embodiment, the information handling devices 102 include computing devices, such as desktop computers, laptop computers, personal digital assistants (PDAs), tablet computers, smart phones, smart televisions (e.g., televisions connected to the Internet), set-top boxes, game consoles, security systems (including security cameras), vehicle on-board computers, or the like. In some embodiments, the information handling devices 102 include wearable devices, such as smart watches, fitness bands, optical head-mounted displays, or the like.

The information handling devices 102 and/or the server 108, may include an embodiment of the routing module 104. In certain embodiments, the routing module 104 is configured to determine multiple routes that a vehicle may traverse to get from a starting point to a selected destination. The routing module 104 may dynamically calculate a projected mileage that the vehicle will traverse to get from the starting point to the selected destination for each route of the multiple routes. The routing module 104 may also determine a cost associated with each route based at least in part on the projected mileage for the respective route. The routing module 104 may use various inputs, such as vehicle and route data, to determine the cost associated with each route. In this manner, the routing module 104 may be used to determine a route that is the lowest cost of the multiple routes.

The data network 106, in one embodiment, includes a digital communication network that transmits digital communications. The data network 106 may include a wireless network, such as a wireless cellular network, a local wireless network, such as a Wi-Fi network, a Bluetooth® network, a near-field communication (NFC) network, an ad hoc network, and/or the like. The data network 106 may include a wide area network (WAN), a storage area network (SAN), a local area network (LAN), an optical fiber network, the internet, or other digital communication network. The data network 106 may include two or more networks. The data network 106 may include one or more servers, routers, switches, and/or other networking equipment. The data network 106 may also include computer readable storage media, such as a hard disk drive, an optical drive, non-volatile memory, random access memory (RAM), or the like.

In one embodiment, the servers 108 include computing devices, such as desktop computers, laptop computers, mainframe computers, cloud servers, virtual servers, and/or the like. In some embodiments, the servers 108 are configured as application servers, email servers, database servers, file servers, game servers, home servers, media servers, web servers, and/or the like. In certain embodiments, the servers 108 are configured to store data related to an identified item, and may be configured to be accessed by one or more information handling devices 102 through the network 106. The servers 108 may include at least a portion of the routing module 104 and may perform one or more operations of the routing module 104.

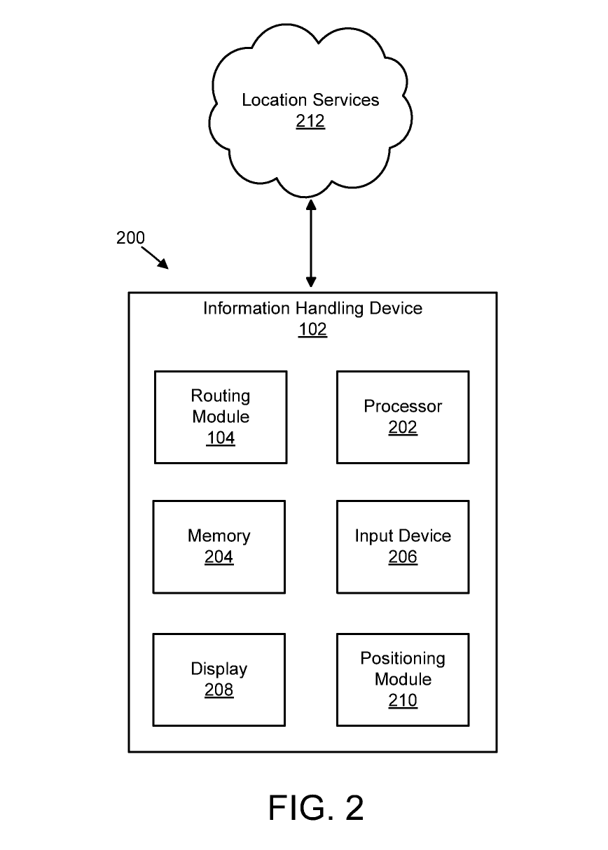

FIG. 2 depicts one embodiment of another system 200 for reducing road travel costs. The system 200 includes the information handling device 102, and the information handling device 102 may contain the routing module 104, a processor 202, a memory 204, an input device 206, a display 208, and a positioning module 210. In some embodiments, the input device 206 and the display 208 are combined into a single device, such as a touchscreen.

The processor 202, in one embodiment, may include any known controller capable of executing computer-readable instructions and/or capable of performing logical operations. For example, the processor 202 may be a microcontroller, a microprocessor, a central processing unit (CPU), a graphics processing unit (GPU), an auxiliary processing unit, a field programmable gate array (FPGA), or similar programmable controller. In some embodiments, the processor 202 executes instructions stored in the memory 204 to perform the methods and routines described herein. The processor 202 is communicatively coupled to the memory 204, the routing module 104, the input device 206, the display 208, and the positioning module 210.

The memory 204, in one embodiment, is a computer readable storage medium. In some embodiments, the memory 204 includes volatile computer storage media. For example, the memory 204 may include a random access memory (RAM), including dynamic RAM (DRAM), synchronous dynamic RAM (SDRAM), and/or static RAM (SRAM). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media.

In some embodiments, the memory 204 stores data relating to vehicle routing. For example, the memory 204 may store vehicle data, route data, and/or any other suitable data. In some embodiments, the memory 204 also stores program code and related data, such as an operating system or other controller algorithms operating on the information handling device 102. The information handling device 102 may use the routing module 104 to determine a low cost route for a vehicle.

As may be appreciated, the routing module 104 may include computer hardware, computer software, or a combination of both computer hardware and computer software. For example, the routing module 104 may include circuitry, or a processor, configured to determine routes that a vehicle may traverse. As another example, the routing module 104 may include computer program code that calculates projected mileage that the vehicle may traverse along each route.

The input device 206, in one embodiment, may include any known computer input device including a touch panel, a button, a keyboard, or the like. For example, the input device 206 may include a handwriting input unit operatively coupled to the processor 202. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be configured to output visual, audible, and/or haptic signals. In some embodiments, the display 208 includes an electronic display capable of outputting visual data to a user. For example, the display 208 may include, but is not limited to, an LCD display, an LED display, an OLED display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime) upon determining a cost for a travel route. In some embodiments, the display 208 includes one or more haptic devices for producing vibrations, motion, or other haptic feedback. For example, the display 208 may produce haptic feedback upon determining the cost for a travel route.

In some embodiments, all or portions of the display 208 may be integrated with the input device 206. For example, the input device 206 and display 208 may form a touchscreen or similar touch-sensitive display. In other embodiments, the display 208 may be located near the input device 206. In certain embodiments, the display 208 may receive instructions and/or data for output from the processor 202 and/or the routing module 104.

The positioning module 210 may be used to determine a geospatial position of the information handling device 102. Furthermore, the positioning module 210 may provide geospatial positioning services to the information handling device 102. For example, the positioning module 210 may be part of a Global Positioning System (GPS) such that the positioning module 210 receives data from satellites to facilitate determining the position of the information handling device 102. The positioning module 210 may communicate with location services 212 to facilitate determining a geospatial position of the information handling device 102. The location services 212 may be any suitable system that facilitates the information handling device 102 determining its geospatial position.

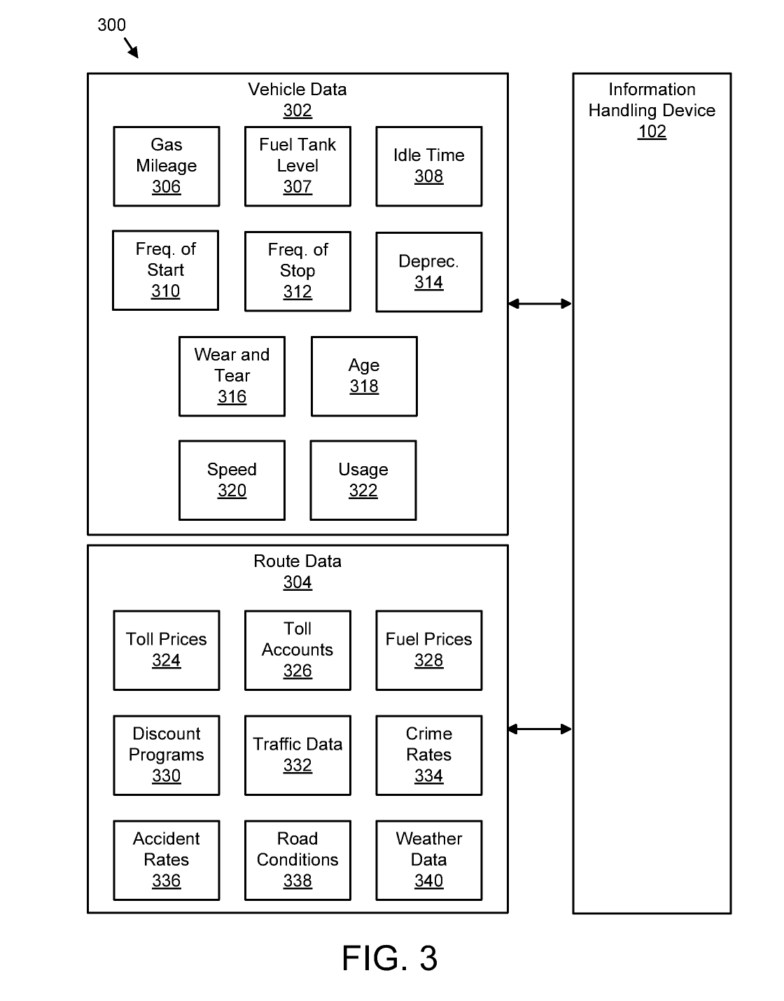

FIG. 3 depicts a schematic block diagram illustrating one embodiment of a further system 300 for reducing road travel costs. The system 300 includes vehicle data 302 and route data 304 provided to the information handling device 102 to facilitate determining cost associated with a route. The vehicle data 302 may include any suitable data about the vehicle that may be used to determine road travel costs. For example, the vehicle data 302 may include gas mileage 306, fuel tank level 307, idle time 308, frequency of starting 310, frequency of stopping 312, depreciation 314, wear and tear 316, age 318, speed 320, usage 322 of the vehicle, and so forth. The vehicle data 302 may be provided to the information handling device 102 directly as an input from an operator, from another information handling device 102, from the server 108, from the data network 106, or from any other suitable device. In some embodiments, the information handling device 102 may receive the vehicle data 302 directly from a vehicle, or from an information handling device 102 integrated with the vehicle.

Moreover, the route data 304 may include any suitable data, about a route that the vehicle may traverse, that may facilitate determining road travel costs. For example, the route data 304 may include toll prices 324, toll accounts 326, fuel prices 328, discount programs 330, traffic data 332, crime rates 334, accident rates 336, road conditions 338, weather data 340, and so forth. The route data 304 may be provided to the information handling device 102 directly as an input from an operator, from another information handling device 102, from the server 108, from the data network 106, or from any other suitable device.

It should be noted that one or multiple types of vehicle data 302 and/or one or multiple types of route data 304 may be used to determine road travel costs. Such types of data may be preselected (e.g., default) and/or selected by an operator to facilitate road travel cost determination tailored to the operator's preferences.

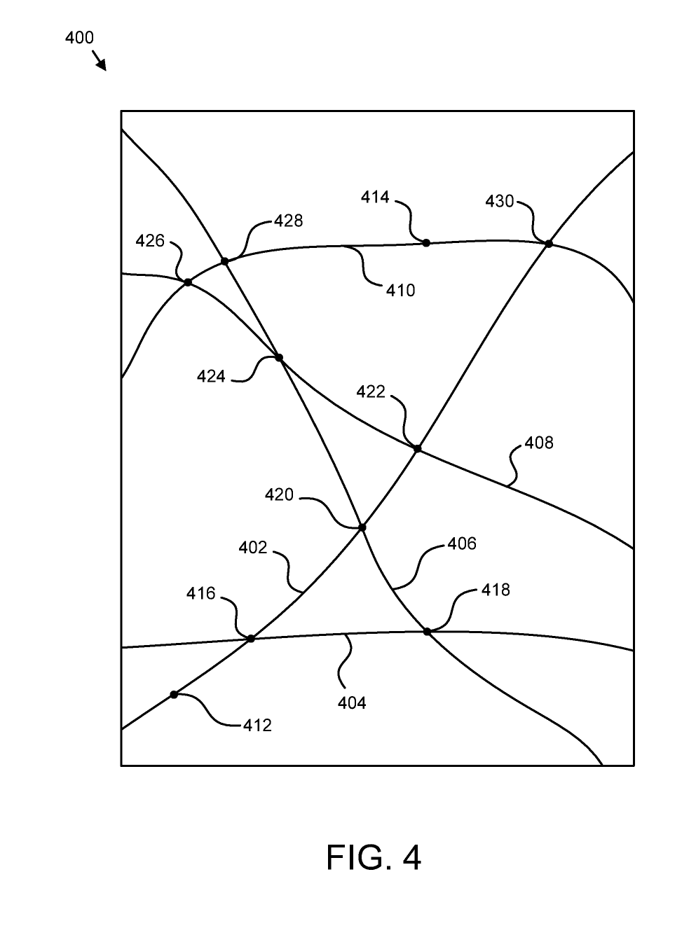

FIG. 4 depicts a map 400 illustrating one embodiment of potential routes that may be taken from a starting point to a selected destination. The map 400 includes roads 402, 404, 406, 408, and 410 with locations 412, 414, 416, 418, 420, 422, 424, 426, 428, and 430 labeled thereon.

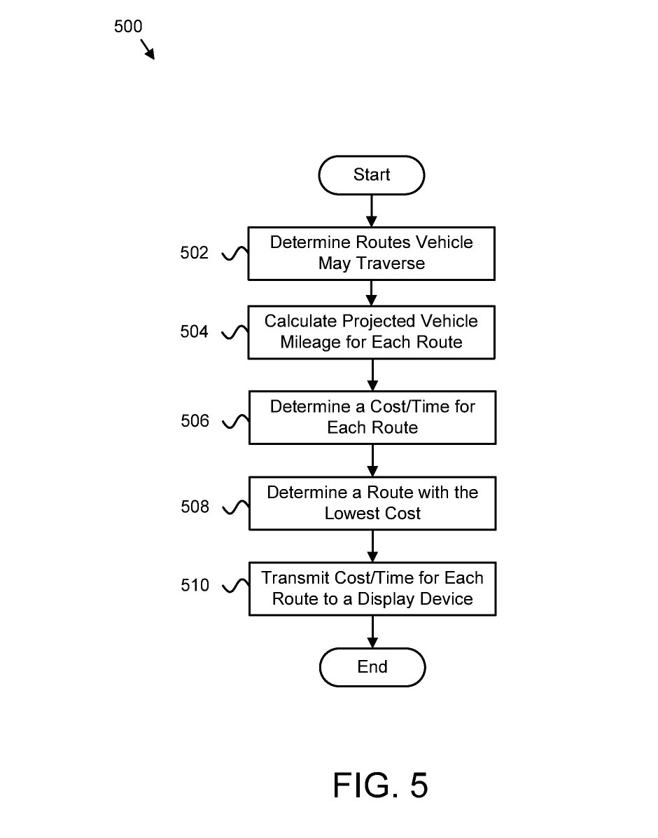

FIG. 5 depicts a schematic flow chart diagram illustrating one embodiment of a method 500 for reducing road travel costs. In some embodiments, the method 500 is performed by a mobile device, such as the information handling device 102 described above with reference to FIGS. 1 and 2. In other embodiments, the method 500 may be performed by a module, such as the routing module 104 described above with reference to FIGS. 1 and 2. In certain embodiments, the method 500 may be performed by a processor executing program code, for example, a microcontroller, a microprocessor, a central processing unit (CPU), a graphics processing unit (GPU), an auxiliary processing unit, a field programmable gate array (FPGA), or the like. It should be noted that the method 500 of FIG. 5 will be described in conjunction with the map 400 of FIG. 4.

The method 500 begins with determining 502 multiple routes that a vehicle may traverse to get from a starting point to a selected destination. For example, in one embodiment illustrated in FIG. 4, the location 412 may be a starting point and location 414 may be a selected destination. In such an embodiment, one route may include locations 412, 416, 420, 424, 426, 428, and 414, while another route may include locations 412, 416, 418, 420, 422, 430, and 414. As may be appreciated, other possible routes may be determined to get from the location 412 to the location 414. In another example, a starting point may be the current location of an operator and a selected destination may be a desired type of location (e.g., a grocery store, a gas station, a restaurant, a mall, a library, and so forth). In such an example, the routes may include routes to different destinations within the desired type of location.

The method 500 continues with dynamically calculating 504 a projected mileage that the vehicle will traverse to get from the starting point to the selected destination for each route. For example, the projected mileage may be calculated along the route including locations 412, 416, 420, 424, 426, 428, and 414, and the vehicle mileage may be calculated along the route including locations 412, 416, 418, 420, 422, 430, and 414. The projected mileage for a route may be used as one factor in determining the overall cost for that route.

The method 500 includes determining 506 a cost and/or a time associated with each route based at least in part on the projected mileage for the respective route. The cost for a route may include many factors, such as vehicle data 302 and route data 304, as set forth previously. For example, the vehicle data 302 may include gas mileage 306, fuel tank level 307, idle time 308, frequency of starting 310, frequency of stopping 312, depreciation 314, wear and tear 316, age 318, speed 320, usage 322 of the vehicle, and so forth. Moreover, the route data 304 may include toll prices 324, toll accounts 326, fuel prices 328, discount programs 330, traffic data 332, crime rates 334, accident rates 336, road conditions 338, weather data 340, and so forth.

It should be noted that, in certain embodiments, one or more information handling devices 102 may be used for determining 506 the cost and/or the time to traverse each route. For example, a first information handling device 102 may be a mobile device, while a second information handling device 102 may be an on-board computer in a vehicle. In such embodiments, the first and second information handling devices 102 may communicate with each other to facilitate sharing of vehicle data, route data, and/or other data.

As an example of determining 506 the cost to traverse a route, in some embodiments, the road 402 between location 412 and 416 may be a toll road. Accordingly, a cost to traverse a route that includes the road 402 between locations 412 and 416 may include the toll price 324 for the road 402 between locations 412 and 416. The toll price 324 may be affected by a toll account 326, therefore, the toll account 326 may be used to determine the appropriate toll price 324. Furthermore, because the toll price 324 may be determined based on a time of day and/or a date, the time of day and/or date may be considered in determining the toll price 324 associated with the route.

The cost to traverse the road 402 between locations 412 and 416 may, in some embodiments, include the cost of fuel to be used during such traversing. As may be appreciated, the cost of fuel may be determined using a number of inputs such as fuel prices 328, gas mileage 306, idle time 308, frequency of starting 310, frequency of stopping 312, speed 320, traffic data 332, discount programs 330, weather data 340, estimated time of travel along the route, and so forth. The cost to traverse the road 402 between locations 412 and 416 may also include depreciation 314, wear and tear 316, age 318, and prior usage 322 of the vehicle to facilitate a determining 506 a comprehensive cost. Furthermore, the cost to traverse the road 402 between locations 412 and 416 may include costs associated with crime rates 334 and accident rates 336. Although crime rates 334 and accident rates 336 may not add a direct cost to the travel, there may be a cost associated with the travel that is proportional to the rates.

Moreover, the cost to traverse the road 402 between locations 412 and 416 may be based at least partly on the estimated time of traversing. Because a person's time is valuable, a cost may be associated with the time that one or more passengers are traveling in the vehicle. While the prior examples have been described in relation to the cost to traverse the road 402 between locations 412 and 416, similar costs may be determined 506 for each road segment between two locations. Accordingly, the overall cost for a route may be determined by combining the costs from the individual road segments.

As may be appreciated, determining 506 the time to traverse each route may include a variety of inputs such as speed limits, average speed, number of stop signs, number of stoplights, refueling stops, stopping to pay tolls, traffic, accidents, road conditions, weather, and so forth. As previously described, the cost to traverse each route may be at least partially based on the time that it takes to traverse the respective route.

In certain embodiments, the method 500 may include determining 508 a route with the lowest cost. Accordingly, the route with the lowest cost may be provided as an output, such as being recommended as the preferred travel route. However, in other embodiments, the method 500 may recommend a route with the lowest cost if the route has a travel time within a preselected tolerance of the shortest travel time. For example, the preselected tolerance may indicate that the route with the lowest cost should have a travel time within 5-10 percent of the shortest travel time, or any other suitable percentage range.

In some embodiment, the method 500 includes transmitting 510 the cost and/or the travel time for each route to a display device. For example, the cost and/or the travel time for each route may be transmitted 510 to the display 208 of the information handling device 102. The cost and/or the travel time for each route may be transmitted 510 in conjunction with the routes to the display 208 to enable selection of a route by the operator. Accordingly, the operator may select a desired route based on the displayed routes, costs, and/or travel times.

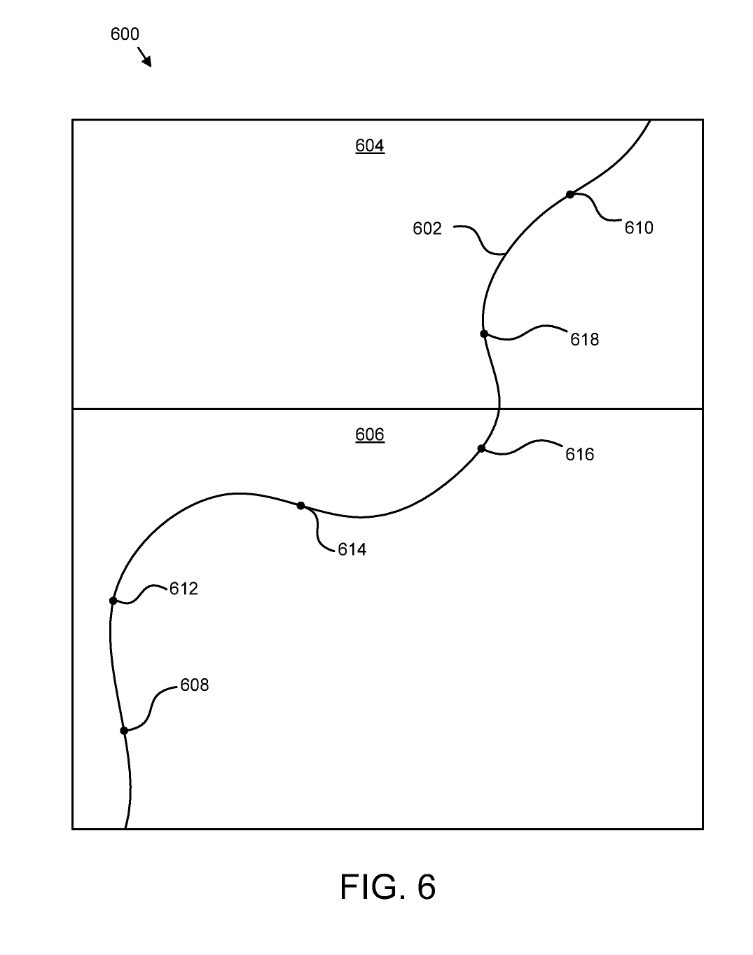

FIG. 6 depicts a map 600 illustrating another embodiment of potential routes that may be taken from a starting point to a selected destination. The map 600 includes a road 602 that extends across two geographic regions 604 and 606. The geographic regions 604 and 606 may be any type of geographic region, such as cities, counties, states, countries, continents, regions, and so forth. As may be appreciated, costs may vary between the geographic regions 604 and 606. For example, fuel prices 328 may be more expensive in one geographic region than in another geographic region. Furthermore, fuel prices 328 may vary considerably within one geographic region.

In certain embodiment, location 608 is a starting point for a route and location 610 is a selected destination. As illustrated in FIG. 6, there is only one road 602 that extends between the locations 608 and 610. However, there may be multiple routes depending on which locations are used as fuel dispensing locations. For example, any one of the locations 608, 612, 614, 616, 618, and 610 may be used as fuel dispensing locations. In one embodiment, a first route includes traveling from the location 608 to the location 614, refueling at the location 614, then traveling from the location 614 to the location 610, and a second route includes traveling from the location 608 to the location 618, refueling at the location 618, then traveling from the location 618 to the location 610. Accordingly, multiple routes may be determined using only one road 602, with the separate routes being defined by locations in which refueling is to occurs (e.g., based on fuel dispensing locations to be used).

As may be appreciated, there may be cost advantages to refueling at specific locations and/or for specific amounts of fuel. Such cost advantages may be accounted for in determining 506 the cost of each route, as described in FIG. 5. Thus, determining 506 the cost of each route may include determining fuel dispensing locations included in each route and/or determining an amount of fuel to dispense at each fuel dispensing location. The fuel dispensing locations and the amount of fuel to dispense may be determined based at least in part on a price of fuel at a respective fuel dispensing location and/or on the fuel tank level (e.g., the amount of fuel remaining in the fuel tank). For example, one route may include starting with a full tank of fuel at location 608, travelling to location 616, refueling with two gallons of fuel, travelling to location 618, filling the fuel tank, and travelling to location 610. In such an example, the fuel tank may be low at location 616, but the fuel cost may be high. In contrast, the fuel cost at location 618 may be low. Therefore, at location 616, only two gallons of fuel are added to the fuel tank to provide sufficient fuel to get the vehicle to location 618 where cheaper fuel is located.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a processor;
a memory that stores code executable by the processor, the code comprising:
code that determines a plurality of routes that a vehicle may traverse to get from a starting point to a selected destination;
code that dynamically calculates a projected mileage that the vehicle will traverse to get from the starting point to the selected destination for each route of the plurality of routes; and
code that determines a cost associated with each route of the plurality of routes based at least in part on the projected mileage for the respective route.

2. The apparatus of claim 1, wherein the code further transmits the cost associated with each route of the plurality of routes in conjunction with the plurality of routes to a display device to enable selection of a route of the plurality of routes.

3. The apparatus of claim 1, wherein the code that determines the cost associated with each route of the plurality of routes further uses vehicle data to determine the cost, wherein the vehicle data comprises one or more of data corresponding to gas mileage, fuel tank level, idle time, frequency of starting, frequency of stopping, depreciation, wear and tear, age, speed, and usage of the vehicle.

4. The apparatus of claim 1, wherein the code that determines the cost associated with each route of the plurality of routes further uses data which comprises one or more of toll prices, toll accounts, fuel prices, discount programs, traffic data, crime rates, accident rates, road conditions, and weather data to determine the cost.

5. The apparatus of claim 1, wherein the code further determines a travel time associated with each route of the plurality of routes and transmits the cost and the travel time associated with each route in conjunction with the plurality of routes to a display device to enable selection of a route of the plurality of routes based on the cost and the travel time.

6. The apparatus of claim 1, wherein the code that determines the plurality of routes that the vehicle may traverse to get from the starting point to the selected destination further determines fuel dispensing locations included in each route of the plurality of routes.

7. The apparatus of claim 6, wherein the code that determines fuel dispensing locations included in each route further determines an amount of fuel to dispense at each fuel dispensing location, and wherein the fuel dispensing locations and the amount of fuel to dispense are determined based at least in part on a price of fuel at a respective fuel dispensing location.

8. A method comprising:
determining, by use of a processor, a plurality of routes that a vehicle may traverse to get from a starting point to a selected destination;
dynamically calculating a projected mileage that the vehicle will traverse to get from the starting point to the selected destination for each route of the plurality of routes; and
determining a cost associated with each route of the plurality of routes based at least in part on the projected mileage for the respective route.

9. The method of claim 8, further comprising transmitting the cost associated with each route of the plurality of routes in conjunction with the plurality of routes to a display device to enable selection of a route of the plurality of routes.

10. The method of claim 8, further comprising determining a route of the plurality of routes with the lowest cost.

11. The method of claim 8, wherein determining the cost associated with each route of the plurality of routes further comprises using vehicle data to determine the cost, wherein the vehicle data comprises one or more of data corresponding to gas mileage, fuel tank level, idle time, frequency of starting, frequency of stopping, depreciation, wear and tear, age, speed, and usage of the vehicle.

12. The method of claim 8, wherein determining the cost associated with each route of the plurality of routes further comprises using data which comprises one or more of toll prices, toll accounts, fuel prices, discount programs, traffic data, crime rates, accident rates, road conditions, and weather data to determine the cost.

13. The method of claim 8, further comprising determining a travel time associated with each route of the plurality of routes and transmitting the cost and the travel time associated with each route in conjunction with the plurality of routes to a display device to enable selection of a route of the plurality of routes based on the cost and the travel time.

14. The method of claim 8, wherein determining the plurality of routes that the vehicle may traverse to get from the starting point to the selected destination further comprises determining fuel dispensing locations included in each route of the plurality of routes.

15. The method of claim 14, wherein determining fuel dispensing locations included in each route further comprises determining an amount of fuel to dispense at each fuel dispensing location.

16. The method of claim 15, further comprising determining the fuel dispensing locations and the amount of fuel to dispense based at least in part on a price of fuel at a respective fuel dispensing location.

17. A program product comprising a computer readable storage medium that stores code executable by a processor, the executable code comprising code to perform:
determining a plurality of routes that a vehicle may traverse to get from a starting point to a selected destination;
dynamically calculating a projected mileage that the vehicle will traverse to get from the starting point to the selected destination for each route of the plurality of routes; and
determining a cost associated with each route of the plurality of routes based at least in part on the projected mileage for the respective route.

18. The program product of claim 17, wherein the code that performs determining the cost associated with each route of the plurality of routes further performs using vehicle data to determine the cost, wherein the vehicle data comprises one or more of data corresponding to gas mileage, fuel tank level, idle time, frequency of starting, frequency of stopping, depreciation, wear and tear, age, speed, and usage of the vehicle.

19. The program product of claim 17, wherein the code that performs determining the cost associated with each route of the plurality of routes further performs using data which comprises one or more of toll prices, toll accounts, fuel prices, discount programs, traffic data, crime rates, accident rates, road conditions, and weather data to determine the cost.

20. The program product of claim 17, wherein the code that performs determining the plurality of routes that the vehicle may traverse to get from the starting point to the selected destination further performs determining fuel dispensing locations included in each route and determining an amount of fuel to dispense at each fuel dispensing location included in each route, wherein the fuel dispensing locations and the amount of fuel to dispense are determined based at least in part on a price of fuel at a respective fuel dispensing location.
